(19) United States
(12) Patent Application Publication
(10) Pub. No.: US 2023/0022268 A1
(43) Pub. Date: Jan. 26, 2023

(54) GENERATING AND ADJUSTING DECISION-MAKING ALGORITHMS USING REINFORCEMENT MACHINE LEARNING

(71) Applicant: INTUIT INC., Mountain View, CA (US)

(72) Inventors: Daniel BEN DAVID, Harel (IL); Sheer DANGOOR, Ramat-Gan (IL); Ido Meir MINTZ, Tel Aviv (IL); Danny ZACH, Karkur (IL)

(21) Appl. No.: 17/384,349

(22) Filed: Jul. 23, 2021

(51) Int. Cl. G06N 5/02; G06K 9/62; G06N 20/00

(52) U.S. Cl. CPC G06N 5/025; G06K 9/6265; G06N 20/00

(57) ABSTRACT

Certain aspects of the present disclosure provide techniques for updating a policy of an agent, including receiving a first transaction file associated with an entity; predicting, by the agent, an expected reward for each respective string of a plurality of strings associated with the first transaction file based on a policy of the agent, wherein the policy is determined based on a context comprising at least an attribute of the entity; determining a first string based on a highest expected reward; providing, to an environment, the first string; receiving a response to the first string, wherein the response comprises an actual reward; and updating the policy of the agent based on the response to the first string.

### INTRODUCTION

Aspects of the present disclosure relate to training a machine learning model, called an agent, to generate tailored text stings for transaction files based on rewards received from an associated environment.

One of the major difficulties with machine learning is that machine learning models, after being trained, work specifically in the way that they are trained, and therefore, may have limited use if presented with a new type of data or situation. Conventionally, if the machine learning model needs to be used with that new type of data or situation, it must be retrained, or a different machine learning model needs to be used.

This problem is compounded by the complexity and variety of real-life situations. For example, if a machine learning model is performing actions based on only previously known types of data, it is unable to adjust to new situations and atmospheres. If the type of input data changes or the underlying characteristics of the input data change, then the model’s performance may be degraded. Thus, for example, if a model is meant to output a price for goods and services when receiving prices of similar goods and services as input, but instead receives trends related to prior prices of those goods and services as input, the model will (1) not output the correct price, or (2) not be able to come up with a price at all based on the new information and the lack of the input it was trained with.

Accordingly, there is a need for methods for performing an action by a machine learning model that receives new types of data and encounters new situations without having to be retrained.

### BRIEF SUMMARY

Certain embodiments provide a method for updating a policy of an agent. The method generally includes receiving a first transaction file associated with an entity; predicting, by the agent, an expected reward for each respective string of a plurality of strings associated with the first transaction file based on a policy of the agent, wherein the policy is determined based on a context comprising at least an attribute of the entity; determining a first string based on a highest expected reward; providing, to an environment, the first string; receiving a response to the first string, wherein the response comprises an actual reward; and updating the policy of the agent based on the response to the first string.

Other embodiments provide processing systems configured to perform the aforementioned method as well as those described here; non-transitory, computer-readable media comprising instructions that, when executed by one or more processors of a processing system, cause the processing system to perform the aforementioned method as well as those described here; a computer program product embodied on a computer-readable storage medium comprising code for performing the aforementioned method as well as those further described here; and a processing system comprising means for performing the aforementioned method as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for determining and performing an action as well as receiving a reward and adjusting a policy.

FIG. 2 depicts an example process for updating a policy based on generating a text string for a transaction file and receiving a reward from an environment.

FIG. 3 depicts an example process for training a reinforcement machine learning model to create and adjust a policy based on transaction files, associated text strings, and rewards associated with the text strings.

FIG. 4 depicts an example agent using a policy to generate text strings.

FIG. 5 depicts an example method of providing a text string that is expected to elicit a highest expected reward and updating a decision making algorithm based on a received actual reward.

FIG. 6 depicts an example method of training an agent to use and adjust a policy.

FIG. 7 depicts an example processing device that may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training an agent to determine an action to perform based on a policy, and a method of updating the policy of the agent.

Determining an action in the face of constantly varying circumstances, such as generating or choosing a text string to highlight or summarize a topic in order to grab a user’s attention, is not a “one size fits all” process. Multiple variables can come into play regarding parties associated with the text string and even the text string itself, such as a party’s likelihood of completing an action when the text string is organized in a certain way, or an amount of money disclosed by the text string.

For example, an email may contain a subject line asking a certain entity to pay an invoice for some product or service rendered. A person may be more likely to pay the invoice if a text string in the subject line addresses him directly than if it is a generic subject line, or if the subject line addresses his company. As another example, a person may be more likely to pay the invoice if the amount is included in the subject line compared to if it is not. For every person or organization receiving the text string, the way each text string is organized or phrased may cause the person or organization to behave differently, making generating the perfect text string for that person or organization a difficult situational task. Thus, conventional methods of generating a standard text string for all entities are not customized for each set of circumstances, and therefore, are less likely to cause the entity to perform a desired action.

Further, conventional machine learning model are trained to perform a technique based on historical sets of data, and need retraining as the data drifts in relevance to current conditions. Thus, for a conventional machine learning model to be able to generate text strings tailored to each transaction file associated with an entity, where each entity had different preferences and situations for each text string, the conventional machine learning model would require periodic retraining as the model performance degrades, which requires extra time and power.

In order to overcome the challenges of conventional methods, embodiments herein describe an automated approach for generating text strings tailored to a specific entity using a machine learning model that may continuously update a policy as entities perform, or do not perform, actions associated with the text strings. In various embodiments, the machine learning model is able to generate multiple text strings for the transaction file and choose a text string that is expected to achieve a highest reward, and, regardless of whether the text string achieves the highest reward, refines its decision-making algorithm (its “policy”) based on the context of the reward, such as the how related entities behaved in the situation and attributes of the text string itself. A reward may be a token generated by an environment based on a response to a certain action of the agent, such as sending a text string associated with a certain topic. In certain instances, the value of the reward may increase or decrease based on the response. As the agent is trained to perform actions that generate the highest reward, when the agent receives a high or low reward in response to a performed action, it will update its policy to reflect that the certain performed action led to that high or low reward in that particular context, and thus may perform the action more or less often, respectively, in similar or the same contexts.

Beneficially, generating the text strings in such a manner allow the text strings to be specifically tailored to the receiving entities, and even further, the machine learning model continues to update its policy to be aware of the situational aspects surrounding each entity and text string, so that it does not need to be manually retrained. The methods herein thus represent a technical solution to an extant technical problem in the related art in that they provide a scalable, repeatable, and accurate way to use a machine learning model to perform actions without requiring the time and power resources necessary to manually retrain the model..

### Brief Introduction to Reinforcement Learning

Reinforcement learning provides a specific training process that prepares a machine learning model (e.g., the agent) to be able to continuously take in new data and change the way it makes decisions based on rewards received for certain inputs without needing to be retrained. The agent that makes decisions based on a decision-making algorithm (called a “policy”), and the agent adjusts the policy as appropriate based on results, or “rewards”, received from a related environment. The agent can take a number of actions with respect to the environment, and the environment, in response, provides a reward for each action. The agent then adjusts its policy in such a way as to perform actions that will result in the highest reward when having to choose between actions in the future. Based on that policy, the agent continues to choose actions to perform with respect to the environment, and will continue to receive rewards, which causes the agent to alter the policy and actions the agent chooses going forward. Thus, the agent continuously updates its policy to adapt to multiple situations as it learns which actions achieve higher rewards based on the circumstances surrounding the actions.

Certain approaches may enhance an agent’s ability to adapt to the multiple situations in which it is attempts to achieve the highest reward. In various embodiments, a context may be used by the agent to help adjust the policy. The context defines one or more aspects of the situation in which the agent attempts to choose the action that will achieve the highest reward. For example, the context may define or receive and use certain attributes of entities of the environment, other objects in the environment, or even relationships between entities within the environment. In a specific example, an attribute could be how likely an entity is to complete a transaction when receiving a tailored text string, generated by the agent, calling for the entity to complete the transaction. The context can be updated with each reward given by the environment, and thus, the context records the attributes relevant to the actions and resulting rewards. The agent then can use the context in order to recognize which attributes lead to higher rewards with regard to certain circumstances and update the policy appropriately.

Thus, when contextualizing each reward with the context, the agent receives both rewards for the actions and the contexts surrounding those rewards, which allows the agent to determine actions with greater precision than conventional reinforcement learning where the agent only received the rewards for the actions.

### Example System for Creating and Adjusting a Policy

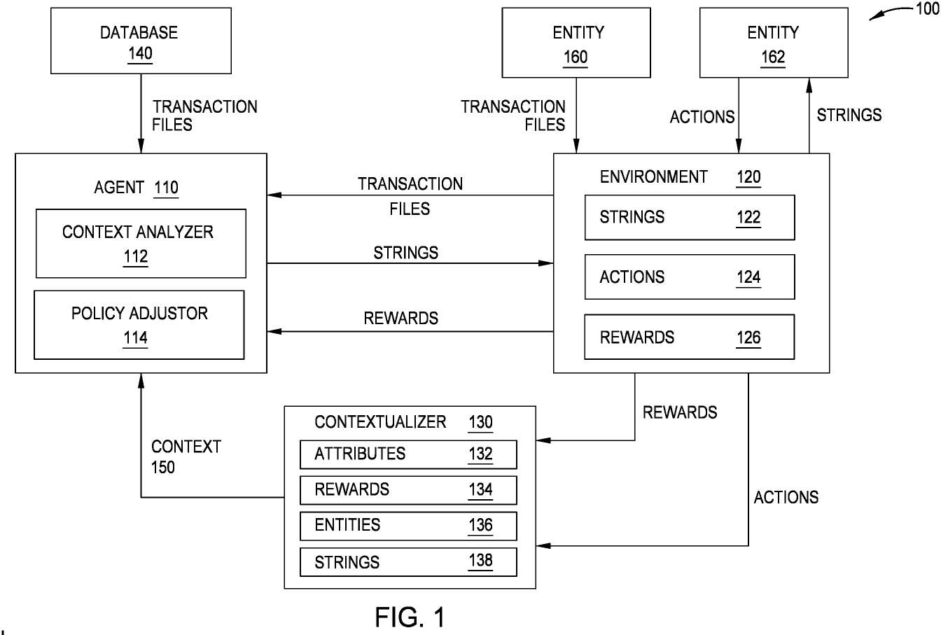

FIG. 1 depicts an example system 100 for generating, using, and adjusting a policy of an agent.

As illustrated, the system 100 includes an agent 110 interacting with an environment 120, a contextualizer 130, and a database 140. The agent performs one or more actions, such as sending one or more text strings, in this depicted example, to environment 120, and receives one or more rewards based on those actions. For example, the agent may decide to send one text string emphasizing how easy it is to make a certain payment (e.g., “Pay Invoice #1111 from Entity 160 with a few clicks!”) as opposed to sending a text string highlighting a certain amount that needs to be paid (e.g., “New Payment Request from Entity 160 for $100.00”) and may receive a reward based on the text string it sent. In other embodiments, the one or more actions may include making certain payments with respect to dates or amounts, may include choosing a specific entity to send a text string or document, or may include generating a specific form that is likely to have an entity return a desired response.

The agent further receives a context 150 from contextualizer 130 based on the actions that it performs and the rewards received from environment 120. In this depicted embodiment, the contextualizer 130 updates the context 150 each time new attributes or rewards are received. In some embodiments, the contextualizer 130 may send a new context with each new reward and action received. In this depicted example, the agent performs the actions with respect to one or more transaction files received (e.g., sending text strings to environment 120). In other embodiments, the agent does not need to receive transaction files, and may perform actions associated with other files or data. Additionally, in other embodiments, the agent may receive one or more transaction files from associated computing devices or even from environment 120. In some cases, the transaction files may be invoices and the text strings may be subject lines aimed towards a particular type or topic for that invoice.

In this example, the agent 110 includes a context analyzer 112 and a policy adjustor 114, which use a policy to determine certain actions to perform and also update the policy as new rewards and updated contexts are received. The policy is a decision-making algorithm modifiable by the agent. The policy generally may include a list of actions performable by the agent (e.g., generating and/or sending a text string to an environment) and includes code indicating what rewards are expected to be received in response to those actions based on previously received rewards and previously performed actions. For example, the code indicating what rewards are expected to be received may include how certain attributes surrounding related entities or transaction files affect rewards that are to be received after an action is performed. As actions are performed and actual rewards are received, the policy may be updated. The updates to the policy may include code indicating that certain actions received a lower or higher actual reward than expected, and thus, the policy may be updated to have new expected rewards for those certain actions. In some cases, the policy may be updated to include new actions that the agent can perform.

Generally, the policy adjustor 114 creates the policy that the agent follows when generating the text strings to send to environment 120. Further, the policy adjustor 114 adjusts the policy based on the rewards and contexts received by the agent 110 so that the agent chooses how to perform an action, such as determining which text strings to generate in order to achieve the highest reward and generating or sending those specific text strings to environment 120. Context analyzer 112 receives and analyzes the context 150 generated by contextualizer 130. Context analyzer 112 may further communicate the results of analyzing the context 150 to policy adjustor 114, which may adjust the policy based on the analysis.

In this depicted example, environment 120 includes strings 122, actions 124, and rewards 126. Generally, the strings 122 may be text strings that are received from the agent 110 and each text string of strings 122 may be associated with one or more actions of actions 124. Each text string of strings 122 may also be associated with a particular topic determined by agent 110, where the particular topic is chosen based on achieving a specific goal (e.g., such as increasing the speed at which a transaction file is paid or how much of that transaction file is paid). The environment 120 may further include processing devices or may be in communication with one or more processing devices (e.g., of entity 160 or entity 162). Environment 120 may receive one or more actions of actions 124 from the agent 110 (e.g., sending the generated text strings) or from those processing devices (e.g., a response from entity 162 with respect to a transaction file). Further, each reward of rewards 126 may be determined by environment 120 and associated with the one or more text strings or actions.

Contextualizer 130 includes attributes 132, rewards 134, entities 136, and strings 138. In this depicted example, contextualizer 130 receives data indicating certain rewards and actions from environment 120. Based on at least one of the rewards and actions from environment 120, contextualizer 130 determines attributes 132, rewards 134, entities 136, and strings 138. In some embodiments, the environment 120 may determine the attributes and provide them to contextualizer 130. In some embodiments, environment 120 may further determine attributes to send to contextualizer 130. In some embodiments, the entities of entities 136 are entities associated with a transaction file, such as a payor (e.g., entity 162) and a vendor (e.g., entity 160).

Additionally, a text string of strings 122 may have been generated by agent 110 and may be associated with the transaction file. Further, in some embodiments, strings 138 may include all text strings that are included in strings 122, but may include only a subset of strings 122 in other embodiments. Even further, the strings 138 may be subject lines that have certain types or topics and are associated with a particular goal, such as increasing a likelihood that a transaction file, such as an invoice, will receive payment.

Attributes 132 may include one or more attributes surrounding rewards 134, entities 136, and strings 138. For example, attributes 132 may include one or more attributes based on a type of each text string in strings 138, a reward associated with each text string in strings 138, and/or a topic of each text string in strings 138.

Attributes may be based on an amount of business an entity of entities 136 receives, an industry associated with an entity, a payment history associated with an entity, an email address of an entity, a number of customers associated with an entity, or a number of transaction files per customer associated with an entity. Additionally, attributes may further be based on an action, such as sending or receiving payment regarding a transaction file that an entity took when receiving a specific text string regarding the transaction file. Even further, attributes may be based on characteristics of one or more specific transaction files associated with the entities, such as a maximum or minimum amount of a transaction associated with a transaction file. Attributes may further be based on what actions related to certain text strings of strings 138 resulted in payment of a transaction file by an entity, and what reward was sent to agent 110 as a result. The attributes described above are exemplary, and other attributes may be used.

For example, an attribute may indicate that entity 162 makes full payments on transaction files within two weeks if it receives a text string associated with the “effort simplification topic”. Another attribute may indicate that entity 160 makes payments on transaction files within one week if it receives a text string associated with the “increased familiarity” topic. Other attributes may show that entity 162 typically makes payments within two weeks, but only makes payments on transaction files associated with entity 160 within four weeks unless the text string is associated with the “call to action” topic. Even further, an attribute may show that entity 162 is within a certain industry (e.g., construction), and another attribute may indicate that entities within the industry make faster payments when receiving text strings with the “anchoring” topic. Another attribute may indicate that entity 162 makes payments on transaction files from entity 160 within one week as long as they are under a specific transaction amount and the accompanying text string is associated with the “anchoring topic”.

In this depicted example, context 150 is created by contextualizer 130 based on the attributes 132 and indicates ones or more aspects surrounding a particular transaction, transaction file, and one or more entities by relating attributes to each other. For example, context 150 may indicate that entity 162 tends to more quickly make payments regarding transaction files (e.g., invoices) associated with entity 160 when sent a text string (e.g., a subject line for the invoice) associated with a first topic, and tends to more slowly make payments when sent a text string associated with a second topic. As another example, context 150 may also indicate that entity 162 tends to more quickly make payments on transaction files under a certain amount when sent a text string associated with a first topic, and tends to more quickly make payments on transaction files over a certain amount when sent a text string associated with a second topic. While these two examples are given, they are exemplary, and context 150 may use attributes 132 to indicate more aspects associated with the transaction, transaction file, and entities. However, the data within context 150 is structured in such a way that the agent 110 may analyze the data and determine which actions (e.g., sending certain text strings to environment 120) will result in higher rewards based on the current context of entities, transaction files, actions, and rewards.

Agent 110 receives context 150 from contextualizer 130 and analyzes the context with context analyzer 112. With the information determined by context analyzer 112, the agent 110 may update its policy with policy adjustor 114 based on the updated information. Thus, as the context 150 is updated and the agent receives rewards based on the text strings it sent out, the context analyzer 112 and policy adjustor 114 allow the agent 110 to update its policy and more appropriately choose actions and text strings based on that policy.

In this depicted example, transaction files may be received from entity 160, entity 162, or database 140. In some embodiments, the transaction files received from database 140 may be stored transaction files for training the agent 110 and creating its policy. Transaction files may include any files associated with a transaction, such as an invoice, an email, a receipt, or a bill.

Further, in this depicted example, the environment 120 communicates with both entity 160 and entity 162. The transaction files may be associated with both entity 160 and entity 162, but may also be associated with only one of entity 160 and entity 162 or more entities than just entity 160 and entity 162. Even further, in this depicted example, only entity 160 delivers transaction files to environment 120, but in other embodiments, entity 162 or other entities may also deliver transaction files to environment 120. Additionally, while in this depicted example, only entity 162 receives text strings and performs actions associated with the transaction files, entity 160 or other entities may receive text strings and perform actions associated with the transaction files.

Thus, the agent 110 creates a policy by interacting with environment 120 and contextualizer 130 by generating text strings with particular topics in order to determine how certain entities, such as entity 160 or entity 162, will respond when receiving those text strings. The agent 110 further updates that policy after receiving a reward from environment 120 as a response from an entity to a particular text string as contextualizer 130 updates the context 150.

### Run-Time Processes for Generating Personalized Text Strings Based on Updated Contexts

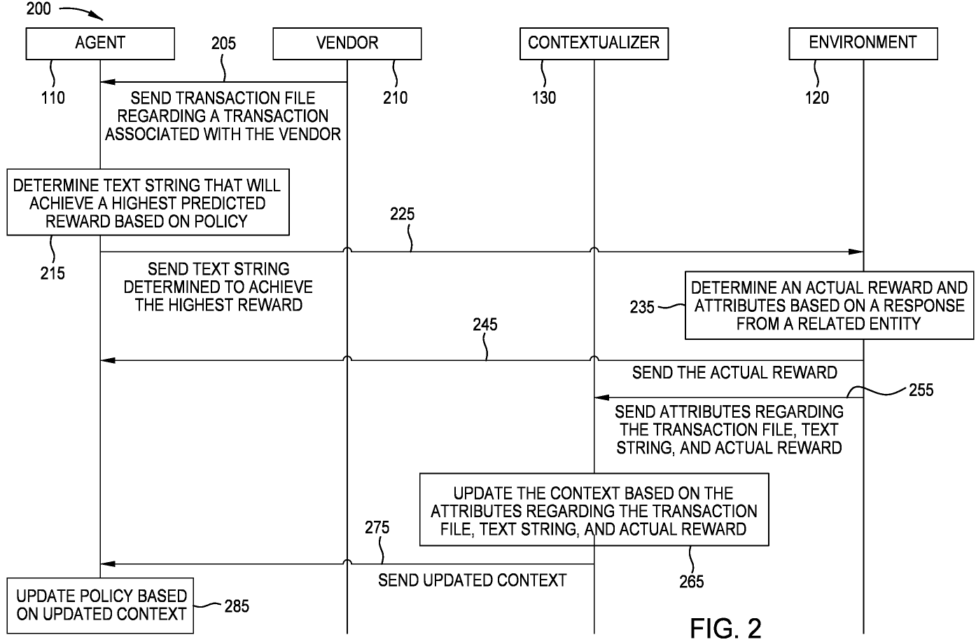

FIG. 2 depicts example process 200 of generating a text string with a particular topic based on a policy of an agent 110 and updating that policy based on a response received from environment 120 and the context (e.g., context 150 of FIG. 1) of contextualizer 130. The text string with the particular topic may be associated with a transaction file from an entity, such as vendor 210.

At step 205, vendor 210 sends agent 110 a transaction file, such as an invoice, associated with vendor 210. In some embodiments, the transaction file may be associated with another entity (e.g., entity 162 of FIG. 1). In other embodiments, the agent 110 may receive the transaction file from a database (e.g., database 140) that may be accessed by vendor 210, for example, a database to which vendor 210 may upload the transaction file. While the transaction file in this depicted example is an invoice, an invoice is exemplary and the transaction file may be a different type of file.

At step 215, agent 110 uses a policy to determine a text string for the transaction file that will receive a highest predicted reward. The agent 110 may be a machine learning model, such as a contextual bandit machine learning model. A contextual bandit model is a machine learning model that develops a policy that it uses to choose between certain actions with respect to an environment, and updates its policy based on rewards received and contexts surrounding the action and environment. The agent 110 may be trained to create and use a policy, where, after being trained, the agent 110 uses the policy to determine an action to perform based on received rewards, where the agent 110 is trained particularly to determine and perform an action that will receive the highest reward. In this depicted embodiment, the agent 110 uses the policy to determine which text string (e.g., a subject line for an invoice) to generate for the transaction file and send to environment 120 based on previously received rewards. In other embodiments, agent 110 does not generate the text string and instead chooses from a set of available modifiable text strings from a database, such as database 140, based on what which available text string the policy indicates would elicit the highest expected reward.

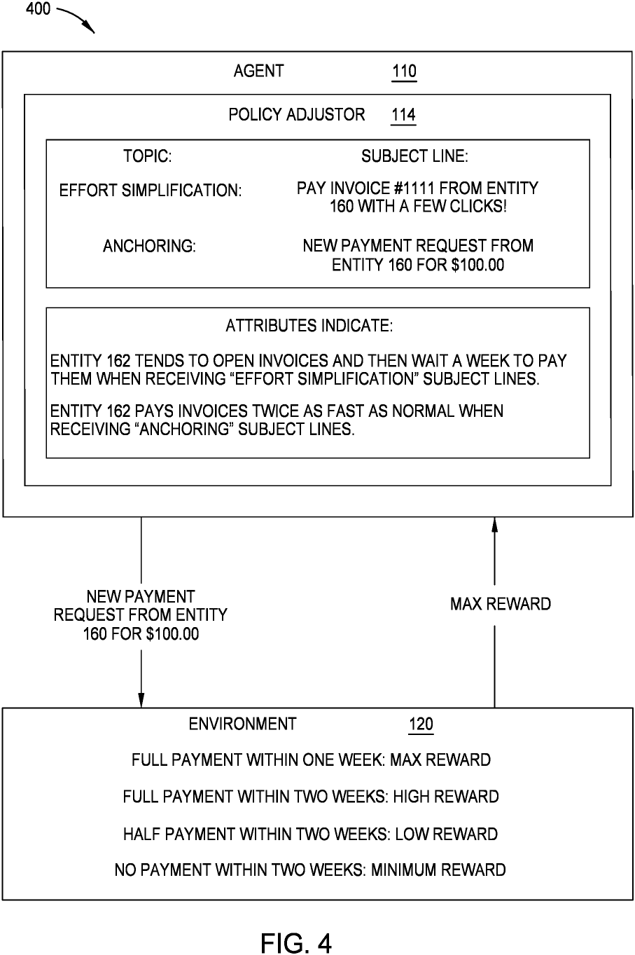

In this depicted example, the policy determines which text strings that the agent 110 generates are expected to elicit a highest reward from environment 120. For example, each text string generated by agent 110 may have an associated topic of a plurality of topics, such as “effort simplification”, “increased familiarity”, a “call for action”, or “anchoring”, as described below with respect to FIG. 4. Agent 110 may determine an expected reward that each particular text string and associated topic will elicit from environment 120. Each expected reward is determined based on the policy of agent 110, which indicates aspects determined from the context surrounding the transaction file, such as what entities are associated with the transaction file, how those entities are related to each other, and how the entities make payments associated with this transaction file or other transaction files. The expected reward may additionally be determined based on attributes of the transaction file itself, such as a payment amount, a type of payments (e.g., lump sum or installments), a payment date, or a transaction location.

The text string sent to environment 120 may also be associated with an actual reward. In some embodiments, that actual reward is based on an action of an associated entity (e.g., entity 152 of FIG. 1) and if the action achieves a specific goal of agent 110 (e.g., receiving faster payment of the transaction file or receiving full payment of the transaction file by a specific date). The associated entity may be a payor of the transaction file associated with the text string, and the action of the entity may be a payment of the transaction file or viewing of the transaction file without making a payment, or another response of the associated entity. Subsequently, the actual reward may be further based on characteristics of the action of the associated entity, such as how much total time the entity took to make the payment, if the entity opened the transaction file, how much of the transaction file the entity paid, if the entity made a minimum payment of the transaction file, and how long it took for the entity to make a payment associated with the transaction file after opening the transaction file. While only certain characteristics are listed above, those characteristics are exemplary and other characteristics may be determined and used in determining the actual reward.

The policy may further define which topics associated with the text strings will elicit the highest actual reward from environment 120 based on a context created by contextualizer 130. The context may contain one or more attributes associated with vendor 210, the transaction file sent by vendor 210, or other data related to an entity associated with vendor 210, that indicate what rewards agent 110 can expect to receive when sending a text string associated with a particular topic or form. For example, the attributes may define how likely an entity will make a payment of the transaction file when receiving a text string associated with a certain topic or an average length of time an entity takes to make a payment of the transaction file when receiving a text string associated with a certain topic.

The attributes may further define an amount of business associated with an entity, such as how many transaction files the entity receives or sends within a time period. The attributes of a transaction file may further include a maximum amount or a minimum amount of an associated transaction, as well as a location or time of the transaction. Other attributes may include an industry of an entity associated with the transaction file, a payment history of an entity associated with the transaction file, a number of customers of an entity associated with the transaction file, or a number of transaction files per customer associated with an entity associated with the transaction file.

The context used by agent 110 frames the attributes in such a way so that the agent 110 may analyze the attributes and update the policy based on the context. The structure of the context may indicate that some attributes are more important than other attributes or may also indicate that some attributes are related to each other. The context may assign weights to attributes in order to indicate which attributes are more important than others. For example, the context may assign a high weight to an attribute indicating that a payor has specifically made payments on transaction files associated with vendor 210 within two weeks when receiving an text string associated with the “anchoring” topic, while assigning a low weight to an attribute indicating the industry of the payor, and that typically, entities in that industry take over four weeks to make payments. The structure of the context may indicate how specific attributes relate to each other by linking those attributes (e.g., linking an attribute indicating what industry an entity belongs to and an attribute indicating that entities in that industry make payments quicker when receiving a text string associated with a specific topic), and a likelihood that certain entities will take a specific action when certain attributes are present and when certain text strings are delivered. For example, the context may indicate how quickly an entity is expected to make a payment when a transaction file total is under a maximum amount when the text string of the transaction file is associated with a particular topic. As another example, the context may indicate that an entity is associated with a specific industry or a specific location, and how quickly entities in that particular industry or location are expected to make a payment of the transaction file when the text string of the transaction file is associated with a particular topic.

Thus, the context defines the circumstances surrounding the entities and the transaction file, and therefore indicates how entities may respond when receiving a transaction file with a text string associated with a particular topic in those circumstances. The agent 110 then uses that context to update its policy for determining which text strings will elicit the highest reward. With that policy, the agent may determine which generated text string and corresponding topic will elicit the highest reward based on the associated entities and attributes

At step 225, after predicting which of the text strings and their corresponding topics will elicit the highest reward (e.g., that text string is associated with a higher expected reward than other text strings), the agent 110 sends the text string and associated transaction file to environment 120. After receiving the text string, the environment 120 may provide it to an associated entity, such as a payor of the transaction file, and may receive a certain action or response (e.g., a payment of the transaction file or viewing of the transaction file and text string without any payment) from the entity.

At step 235, the environment 120 determines an actual reward corresponding to the action or response from the entity, and additionally determines one or more attributes associated with related entities and/or the transaction file. In other embodiments, the context may determine the one or more attributes from data received from environment 120.

At step 245, the environment 120 sends the actual reward based on the response to the agent 110 so that the agent 110 may update the policy based on the actual reward for the text string and associated topic. For example, if the agent sends a text string associated with a certain topic with a highest expected reward, but receives a low actual reward (e.g., because an entity did not make a payment of the transaction file with a certain date), the agent 110 may update its policy to adjust the expected rewards of the text strings associated with that particular topic. As another example, if the agent sends a text string associated with a certain topic with a highest expected reward, and receives an actual reward higher than the expected reward (e.g., because an entity made a payment of the transaction file more quickly than expected), the agent may 110 update its policy to adjust the expected rewards of the text strings associated with that particular topic. Thus, when the agent 110 receives a new transaction file, the expected rewards will have been adjusted based on previous actual rewards.

At step 255, the environment 120 determines and sends attributes to the contextualizer 130 so that the contextualizer may update the context. In some embodiments, the attributes may concern the entities related to the transaction file, the actions of entities related to the transaction file, aspects of the transaction file itself, or other related attributes, as described below with respect to FIG. 4.

At step 265, the contextualizer 130 updates the context based on the attributes determined by the environment 120. The context relates the attributes and associated data in such a way that the agent 110 may analyze the context to understand the circumstances surrounding the entities and transaction file. For example, the context may indicate that a certain entity will more quickly make a payment associated with a transaction file when the transaction file has a text string associated with a certain topic. As another example, the context may indicate that the same entity is more likely than to make a payment than to not make a payment when the transaction file is less than a maximum amount and the text string is associated with a different topic.

At step 275, the contextualizer 130 sends the updated context to agent 110.

At step 285, the agent 110 updates the policy based on the updated context. For example, the updated context reflects any updated attributes concerning any entity associated with the transaction file or the transaction file itself. For example, the updated context may indicate that the expected reward determined by the agent 110 was higher than the actual reward based on the response by an associated entity, and thus, the agent 110 may adjust its policy to indicate that text strings associated with a particular topic do not elicit as high of actual rewards as the context previously indicated, and thus, may not choose or may be less likely to choose that topic under similar circumstances. As another example, the updated context may indicate that the entity made a payment associated with the transaction file faster than the previous context indicated, which would elicit a higher actual reward, and thus, the agent 110 may adjust its policy to indicate that text strings associated with a particular topic elicit higher actual rewards than the context previously indicated, and thus, may be more likely to choose that topic under similar circumstances.

Thus, as new transaction files are received by the agent 110, the agent 110 may choose specific text strings with particular topics for an associated entity to receive. Based on the rewards and attributes determined by environment 120, the contextualizer 130 updates the context so that agent 110 can update its decision-making policy as with each new text string it sends out.

### Training an Agent to Create and Update Its Decision-Making Policy

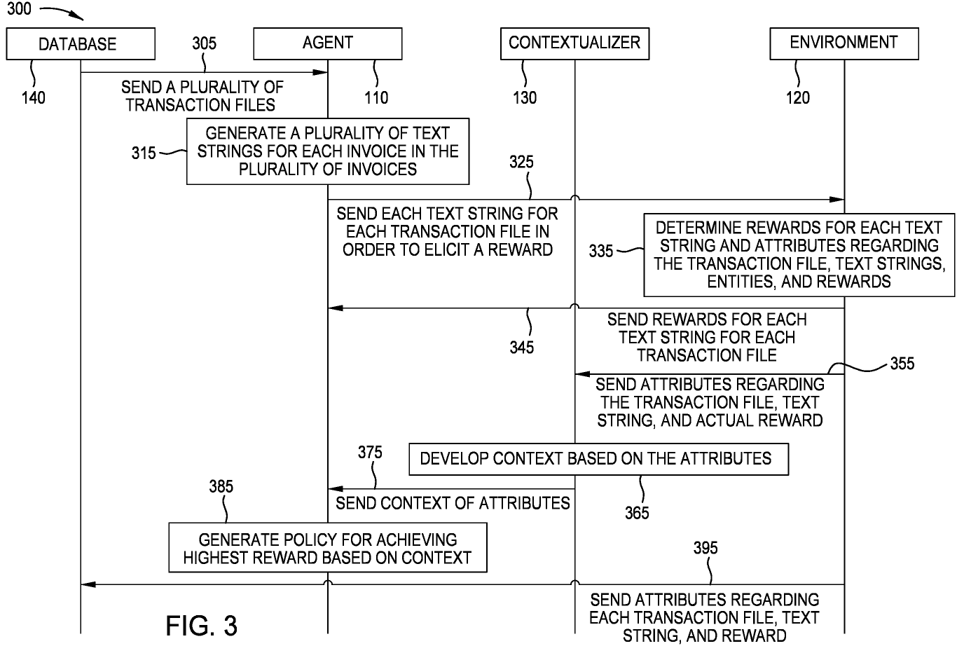

FIG. 3 depicts example process 300 of training an agent 110, using reinforcement learning, to generate a plurality of text strings and determine a certain text string out of the plurality of text strings that will elicit the highest actual reward from environment 120. The agent 110 may be trained by providing multiple text strings to the agent along with a reward for each text string, so that the agent may generate a policy for determining actions that will elicit a highest reward based on the rewards for each text string, as described below. In some embodiments, the agent will generate the policy for determining actions that will elicit the highest rewards based on both the rewards for each text string and a related context. Each text string in the plurality may be associated with a respective topic, and determining which certain text string will elicit the highest actual reward may be based on the respective topic associated with the certain text string.

In this depicted example, at step 305, database 140 sends a plurality of transaction files, such as an invoice, to agent 110 so that agent 110 can generate a plurality of text strings, such as different text strings, for each transaction file. Database 140 may contain the plurality of transaction files associated with one or more entities (e.g., entity 160 and entity 162 of FIG. 1, and vendor 210 of FIG. 2). In some cases, associated entities may upload certain transaction files to database 140 to be used in training the agent. In certain embodiments, agent 110 may be trained with a plurality of transaction files and multiple text strings for each transaction file, as well as the rewards associated with each of those text strings.

At step 315, the agent 110 generates the plurality of text strings for each transaction file. In some embodiments, each text string of the plurality of text strings may be associated with a particular topic. Each particular topic may be associated with a particular goal, such as making payments of the transaction file seem easier than it normally would be, personalizing the text string towards the recipient, emphasizing an amount associated with the transaction file, or calling the recipient of the transaction file to a particular action (such as paying the transaction file), or increasing or decreasing the length of text string.

At step 325, the agent 110 sends each text string of the plurality of text strings in order to elicit a reward for each of the text strings.

At step 335, the environment 120 determines (1) rewards for each text string of the plurality of text strings and (2) attributes surrounding any associated entities and the transaction file itself, as described above with respect to FIG. 2. In some embodiments, the reward for each text string is based on potential actions of an associated entity, such as paying an amount associated with the transaction file, and their likelihood of occurring. The reward may further be based on aspects of that action, such as the speed at which the transaction file was paid, an amount of time between when the transaction file was open and when the transaction file was paid, or a likelihood that the transaction file may not be paid. While certain aspects are listed above, these aspects are exemplary and other aspects may be determined by environment 120.

At step 345, the environment 120 provides the rewards for each text string to agent 110 so that the agent may determine which text strings elicited the highest rewards.

At step 355, the environment 120 sends the determined attributes to contextualizer 130. Environment 120 may further send actions taken by entities associated with the transaction file, rewards that were determined based on those actions, and the text strings that elicited those rewards to contextualizer 130. In other embodiments, environment 120 may only send relevant data and contextualizer may determine the attributes.

At step 365, the contextualizer 130 generates the context of attributes based on the received attributes from environment 120. The context of attributes relates the attributes to the entities, transaction files, and text strings so that the agent 110 may analyze the context and determine which text strings and topics elicit the highest rewards for each particular entity and/or transaction file.

At step 375, the contextualizer 130 sends the context of attributes to the agent 110.

At step 385, a policy for generating text strings with certain topics is created based on the rewards received from the environment for each text string from environment 120 as well as the context of attributes received from contextualizer 130. In some embodiments, the agent 110 itself generates the policy. In other embodiments, the policy is generated elsewhere and is received by agent 110. The policy may indicate, based on the received rewards, the context, and a new transaction file, which text strings and topics will elicit the highest rewards from environment 120. Thus, by using the policy, the agent 110 can predict what text string is the best to send to environment 120 and elicit the highest reward (e.g., because a related entity made a quick and/or full payment).

At step 395, the environment 120 sends the determined attributes regarding each transaction file, the text string and topics, rewards, and related entities to database 140 to be stored for future use. For example, agent 110 may reference previous attributes when updating its policy in order to recognize trends in entity behavior.

Thus, by training agent 110 to develop a decision-making policy that allows it to determine which actions, such as generating and sending text strings associated with certain topics for a transaction file, will receive the highest rewards, and therefore, is trained to make decisions when presented with multiple situations. The agent may then continue to update its policy to refine its decision-making process.

### Example Determination of Text Strings and Topics

FIG. 4 depicts an example agent 110 interacting with environment 120 by determining a text strings (e.g., subject lines) with a particular topic to send to environment 120 in order to elicit a highest actual reward.

As described above with respect to FIGS. 1-3, agent 110 uses a policy in order to determine what text strings will have a highest expected reward from environment 120. Environment 120 may determine rewards based on actions or responses from entities associated with a transaction file (e.g., an invoice) associated with the text string (e.g., entity 160 or entity 162).

Policy adjustor 114 of agent 110 may adjust the policy of agent 110 as well as use the policy in order to determine which text string has a highest expected reward. In this depicted embodiment, each possible text string is associated with a topic, where a text string associated with a first topic may elicit a higher expected reward than a text string associated with a second topic. Some examples of topics may be “effort simplification” (e.g., highlighting the ease of paying the transaction file) or “anchoring” (e.g., showing an amount owed or a date due), as shown. Other examples of topics may be “increased intimacy”, which may focus on personalizing a text string by including the recipient’s first name or a similar personalization, or “call to action”, which may highlight the request and how a recipient might fulfill the request. Another example of a topic may be “increased formality”, which may focus on creating the shortest possible text string. While only some examples of topics are listed, these topics are exemplary, and other topics may be used.

As depicted in this example, the policy adjustor 114 generates a text string for the “effort simplification” topic (e.g., “Pay Invoice #1111 from Entity 160 with a few clicks!”) and the “anchoring” topic (e.g., “New Payment Request from Entity 160 for $100.00”). While only two text strings are generated in this example, generating two text strings is exemplary, and any number of text strings may be generated.

Additionally, while only one text string is generated per topic in this depicted example, multiple text strings for each topic may be generated. For example, “New Payment Request from Entity 160 for $100.00” and “New Payment Request from Entity 160 due on Jul. 1, 2021” may both be associated with the “Anchoring” topic for the same transaction file.

As described above with respect to FIGS. 1-3, the policy of agent 110 may use attributes determined by environment 120 in order to determine which text strings may elicit the highest expected reward from environment 120, and policy adjustor 114 may further determine different expected rewards for each text string for each topic based on determined attributes. For example, the policy adjustor 114 may determine that the text string “Pay Invoice #1111 from Entity 160 with a few clicks!” results in a low expected reward because it is associated with the “Effort Simplification” topic, whereas the policy adjustor 114 may determine that the text string “New Payment Request from Entity 160 for $100.00” results in a high expected reward because it is associated with the “Anchoring” topic.

In this depicted example, the policy may indicate which topics or variations of text strings elicit higher rewards. In some embodiments, a reward may be based on a particular goal that the agent 110 is trying to achieve, such as receiving a payment for the transaction file quickly or receiving a full, one-time payment for the transaction file. The policy adjustor 114 may then choose a generated text string based on how likely the text string will allow the agent 110 to achieve that goal, and thus receive a higher reward. For example, in this depicted example, the policy indicates that “Entity 162 tends to open invoices and then wait a week to pay them” when receiving “effort simplification” text strings, but also indicates “Entity 162 pays invoices twice as fast as normal” when receiving “Anchoring” text strings. Thus, since the “Anchoring” text strings increase the likelihood of the agent 110 achieving its goal (e.g., a faster speed of invoice payments), the policy adjustor 114 chooses the generated an “anchoring” text string and sends it to environment 120.

In this depicted example, environment 120 includes standards for which responses from associated entities result in the highest rewards. Thus, in this depicted example, receiving a full payment within one week results in a maximum reward, receiving a full payment within two weeks results in a high reward, receiving a half payment within two weeks results in a low reward, and no payment within two weeks results in a minimum or a “zero” reward, where a “zero” reward is a response from the environment that indicates no beneficial action was taken by a related entity. Thus, in this depicted example, the environment 120 may deliver the text string with the transaction file to an entity and receive a full payment within one week, which results in a maximum reward from the environment 120. While certain standards are shown within environment 120, those standards are exemplary and other standards, or no standards, may be used.

In some embodiments, the rewards may include negative rewards, called penalties. For example, if a text string associated with a certain topic was sent to the related entity, but no payment was received after six months, the environment may send a penalty to the agent 110. In those embodiments, while rewards would be positive tokens for the agent 110 to use in updating the policy that would cause the agent 110 to actions related to those rewards, penalties may cause the agent 110 to not take actions related to those penalties. For example, if the agent sends a text string with the topic of “increased familiarity”, but a related entity does not make a payment within six months, the agent 110 may receive a penalty instead of a reward. In some embodiments, if the agent 110 receives a threshold amount of penalties defined by the policy, it may choose not to perform an action that previously caused the agent 110 to receive those penalties.

After receiving the actual reward from environment 120, the policy adjustor 114 adjusts the policy of agent 110 based on the actual reward. For example, for the policy adjustor 114 may adjust the policy to indicate that “anchoring” text strings in general receive higher rewards than “effort simplification” text strings, or that “anchoring” text strings are most likely to receive a maximum reward. The policy adjustor 114 may further adjust the policy based on attributes surrounding the entities or the transaction file (e.g., attributes that are framed by contextualizer 130 of FIG. 1). For example, the policy adjustor 114 may adjust the policy to indicate that “anchoring” text strings are more likely to receive maximum rewards when entity 162 is involved, but not when other entities are involved.

The policy may be further adjusted based on certain attributes of the entities associated with the transaction file, the text string, the rewards, and/or the transaction file itself. The attributes may indicate the likelihood of an entity performing a certain action under certain circumstances and thus, also may indicate the likelihood of the agent receiving a high reward under those circumstances after sending a particular text string. Attributes may surround various aspects of the agent, the environment, the related entities, the text strings, and the transaction file itself.

For example, attributes surrounding the various entities may include what actions entities have taken when receiving text strings associated with a particular topic for a transaction file requiring a payment of a certain amount, the relationship between entities associated with the transaction file, what types of payments an entity typically makes (e.g., a full payment, a half-payment, or payments of installments), what industry an entity practices in, and a location of an entity. Attributes may also include how the entities related to the transaction file have acted when receiving a past transaction file or paying a past transaction file from the other entity, including if an entity paid on time, how the entity paid (e.g., made a full one-time payment), if the entity paid at all, and if the entity opened the transaction file. Additionally, each of previously listed attributes may be varied based on actions taken by certain entities when receiving text strings associated with a particular topic. Further, each of the previously listed attributes is exemplary, and other attributes may be used.

Thus, the agent 110, through policy adjustor 114, can continuously adjust the policy of the agent in order to account for all situations and updating circumstances surrounding the related entities and the transaction file.

### Example Method of Run-Time Processes

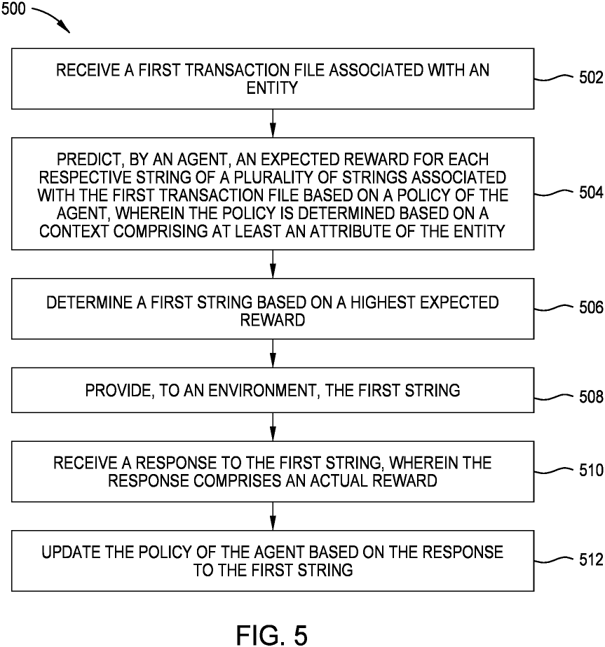

FIG. 5 depicts an example method 500 of updating a policy of an agent (e.g., agent 110 of FIG. 1), such as described above with respect to FIGS. 1-2. In some embodiments, the agent may be a contextual bandit machine learning model.

Method 500 begins at step 502 with the agent receiving a first transaction file associated with an entity (e.g., entity 160 or entity 162 of FIG. 1 or vendor 210 of FIG. 2). The first transaction file may be an invoice associated with the entity as well as a payor.

Method 500 then proceeds to step 504 with predicting, by the agent, an expected reward for each respective text string of a plurality of text strings associated with the first transaction file based on a policy of the agent. The policy of the agent may be a decision-making algorithm used by the agent to determine what actions, when performed with respect to an environment (e.g., environment 120 of FIGS. 1-4), will cause the environment to return the highest reward. Those actions may include sending a text string, such as a text string for the first transaction file, to the environment, where the text strings may correspond to one or more topics and the rewards may be based on a response to each text string by a related entity or payor. The agent may generate the policy based on previous actions and the rewards received for those previous actions, and the agent may further update the policy as it performs actions based on those actions and rewards received based on those actions. Additionally, the policy may further be generated based on a context of attributes surrounding the entity, the payor, and the transaction file itself.

Method 500 then proceeds to step 506 with determining a first text string based on a highest expected reward. The highest expected reward may come from the environment and may be based on an action of a related entity, such as an expected speed of payment or expected payment amount of the transaction file. The agent may determine an expected reward for multiple possible text strings based on the context surrounding the entity, payor, and transaction file, as well as previous rewards received for text strings associated with the same topic. In some cases, the agent may generate a plurality of text strings and choose the one with the highest expected reward.

Method 500 then proceeds to step 508 with providing, to the environment, the first text string. In some embodiments, after being provided to the environment, a related entity, such as the payor, may perform an action related to the transaction file, such as opening the transaction file but not making a payment, making a payment of the transaction file, or not opening the transaction file at all.

Method 500 then proceeds to step 510 with receiving a response to the first text string, wherein the response comprises an actual reward. In some embodiments, the response is received from the environment and the actual reward is based on the action performed by the related entity. The actual reward may be the same or different than the expected reward for the first text string.

Method 500 then proceeds to step 512 with updating the policy of the agent based on the response to the first text string. The agent may update its own policy specifically based on a comparison of the actual reward to the expected reward for the first text string. The policy of the agent may further be updated based on an updated context related to the transaction file. For example, the environment may determine one or more attributes related to the related entities or the transaction file, and the context surrounding the entities and the transaction file may be updated based on those attributes. The context may further be updated based on actual and expected rewards related to any text strings, entities, or transaction files. The agent may then further update its policy based on how those attributes affect the updated context.

In some embodiments, the agent may generate the plurality of text strings based on its policy. Each of those text strings may also be associated with a topic, such as “effort simplification”, “anchoring”, “increased intimacy”, “call to action”, or “increased formality”.

In some embodiments, the expected reward for each text string is based on a likelihood that a payment for a transaction associated with the first transaction file will be received. The expected reward for each text string may further be based upon a likelihood that a certain percentage of the payment for the transaction may be received. The expected reward for each text string may even further be based on the type of payment for the transaction that is expected to be received. The expected reward for each text string may also be based on how long a related entity is expected to wait before making a payment for the transaction. The actual reward may be based on an action of a related entity, such as the payment of the transaction related to the transaction file, as well as based on characteristics of the action, such as how long the related entity took to pay, what type of payment the entity made, and if the entity made a full payment.

### Example Method of Training an Agent to Determine and Perform an Action

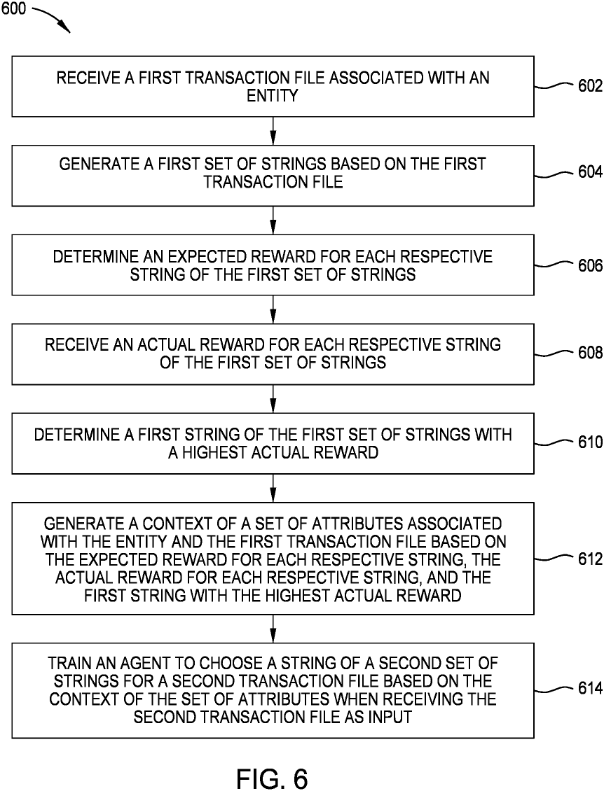

FIG. 6 depicts an example method 600 of training an agent (e.g., agent 110 of FIG. 1) to use a policy based on received rewards for multiple text strings for each associated transaction file, such as described with respect to FIGS. 1 and 3. In some embodiments, the agent may be a contextual bandit machine learning model.

Method 600 begins at step 602 with receiving a first transaction file associated with an entity (e.g., entity 160 or entity 162 of FIG. 1), where the first transaction file may be one transaction file out of a plurality of transaction files associated with a plurality of entities including the entity associated with the first transaction file. The first transaction file may be an invoice associated with the entity as well as a payor.

Method 600 then proceeds to step 604 with generating a first set of text strings based on the first transaction file. Each text string of the first set of text strings may correspond to a topic, such as “effort simplification”, “anchoring”, “increased intimacy”, “call to action”, or “increased formality”. In some embodiments, each text string of the first set of text strings is a text string for the first transaction file, which may be an invoice. A set of text strings may also be generated for each transaction file in the plurality of transaction files.

Method 600 then proceeds to step 606 with determining an expected reward for each respective text string of the first set of text strings. Each expected reward may be based on the likelihood that a related entity, such as a payor of the transaction file, will perform an action. The expected reward may further be based on the how the related entity might perform that action, such as how quickly the related entity may submit a payment or how much of an amount of the transaction file the related entity will pay. After determining the expected reward for each respective text string of the first set of text strings, the respective text strings may then be ranked by those expected rewards. In some embodiments, expected rewards are determined for each text string associated with each transaction file in the plurality of transaction files.

Method 600 then proceeds to step 608 with receiving an actual reward for each respective text string of the first set of text strings. The actual reward for each respective text string of the first set of text strings may be received from an environment (e.g., environment 120 of FIG. 1) in communication with related entities. The actual reward may be generated by the environment based on the most likely action an entity would have performed. In some embodiments, an actual reward is received for each text string with each transaction file in the plurality of transaction files.

Method 600 then proceeds to step 610 with determining a first text string of the first set of text strings with a highest actual reward.

Method 600 then proceeds to step 612 with generating a context of a set of attributes associated with the entity and the first transaction file based on the expected reward for each respective text string, the actual reward for each respective text string, and the first text string with the highest actual reward. The context may be created by a contextualizer (e.g., contextualizer 130 of FIGS. 1-3). The attributes of the context may be related to one or more related entities, the relationship between the entities, the first transaction file, one or more of the generated text strings, and one or more of the actual or expected rewards. The context may further relate the attributes to each other so that the context may be analyzed to determine which text strings and topics may elicit the highest rewards based on the given attributes.

Method 600 then proceeds to step 614 with training the agent to choose a text string of a second set of text strings for a second transaction file based on the context of the set of attributes and the previously received rewards when receiving the second transaction file as input. The second transaction file may also be part of the plurality of received transaction files. Training the agent may include generating a policy based on the previously received rewards and context that the agent uses to choose which text string to send to an environment. The agent may update its policy based on new contexts and received rewards. Further, the context, and therefore, the policy, may be updated each time the agent receives an actual reward after performing an action, such as sending a text string with a particular topic. Thus, as the agent continues to determine the expected rewards for text strings and receive actual rewards for those text strings, the context, and thus, the policy, will continue to be updated so that the agent can more accurately choose which text strings will generate the highest actual rewards.

### Example Processing Device

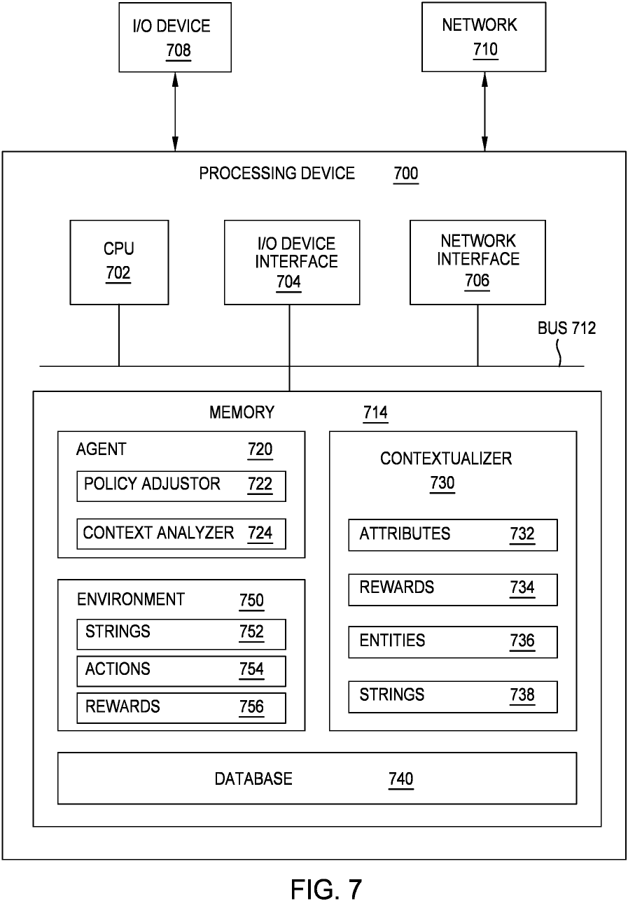

FIG. 7 depicts an example processing device 700 that may perform the methods described herein with respect to FIGS. 5-6. For example, the processing device 700 can be a physical processing device or virtual server and is not limited to a single processing device that performs the methods described above.

Processing device 700 includes a central processing unit (CPU) 702 connected to a data bus 712. CPU 702 is configured to process computer-executable instructions, e.g., stored in memory 714, and to cause the processing device 700 to perform methods described above. CPU 702 is included to be representative of a single CPU, multiple CPUs, a single CPU having multiple processing cores, and other forms of processing architecture capable of executing computer-executable instructions.

Processing device 700 further includes input/output (I/O) device(s) 708 and I/O device interfaces 704, which allows processing device 700 to interface with input/output devices 708, such as, for example, keyboards, displays, mouse devices, pen input, and other devices that allow for interaction with processing device 700. Note that processing device 700 may connect with external I/O devices through physical and wireless connections (e.g., an external display device).

Processing device 700 further includes a network interface 706, which provides processing device 700 with access to external network 710 and thereby external personal devices.

Processing device 700 further includes memory 714, which in this example includes an agent 720, contextualizer 730, database 740, and environment 750.

In this depicted example, agent 720 further includes policy adjustor 722 and context analyzer 724. Context analyzer 724 may receive a context (e.g., context 150 of FIG. 1) from contextualizer 730 and analyze the context so that policy adjustor 722 may use create and/or adjust the decision-making policy of the agent based on that analysis. Policy adjustor 722 may further create and/or adjust the policy based on receiving one or more rewards from environment 750. Agent 720 may further perform one or more actions (e.g., generating and sending a certain text string associated with a specific topic for a transaction file) based on that policy.

Contextualizer 730 further includes attributes 732, rewards 734, entities 736, and strings 738. Attributes 732 may be received from environment 750 and are used by contextualizer 730 in order to show certain circumstances surrounding related entities and a transaction file. Contextualizer 730 may further use rewards 734, entities 736, and strings 738 to further define the circumstances surrounding certain entities and transaction files. For example, contextualizer 730 may use the attributes to show that a certain reward was received when an entity performed an action in response to receiving a text string. Contextualizer 730 may otherwise show that certain rewards were received when text strings were sent to entities while certain attributes were present. Thus, the contextualizer may use attributes 732, rewards 734, entities 736, and strings 738 in order to create a context for the context analyzer 724 to analyze.

Environment 750 further includes strings 752, actions 754, and rewards 756. Environment 750 may further be in communication agent 720 to receive text strings that will be stored in strings 752. Environment 750 may receive certain actions performed by entities that are associated with transaction files or text strings. Environment 750 may further determine rewards 756 using the text strings and transaction files sent to the entities, as well as the actions performed by the entities. Rewards 756 includes a reward for each particular text string based on an associated entity action in response to receiving that text string. Thus, as agent 720 sends text strings to environment 750, and later receives rewards from environment 750 associated with those text strings, the policy adjust 722 may continuously adjust the policy in order to generate text strings that will elicit the highest rewards.

Database 740 may include historical transaction files, text strings associated with those historical transaction files, and rewards associated with those text strings, as well as attributes related to each of the transaction files, text strings, and rewards. In some embodiments, the agent 720 may be trained to create and adjust its policy based on the historical transaction files, text strings, and rewards stored in database 740. Additionally, incoming transaction files may be stored in database 740, as well as generated text strings and received rewards.

Note that while shown as a single memory 714 in FIG. 7 for simplicity, the various aspects stored in memory 714 may be stored in different physical memories, but all accessible by CPU 1102 via internal data connections such as bus 712. While not depicted, other aspects may be included in memory 714.

Note that FIG. 7 is just one example of a processing system, and other processing systems including fewer, additional, or alternative aspects are possible consistent with this disclosure.

### Example Clauses

Implementation examples are described in the following numbered clauses:

Clause 1: A method of updating a policy of an agent, comprising: receiving a first transaction file associated with an entity; predicting, by the agent, an expected reward for each respective string of a plurality of strings associated with the first transaction file based on a policy of the agent, wherein the policy is determined based on a context comprising at least an attribute of the entity; determining a first string based on a highest expected reward; providing, to an environment, the first string; receiving a response to the first string, wherein the response comprises an actual reward; and updating the policy of the agent based on the response to the first string.

Clause 2: The method of Clause 1, further comprising generating, based on the policy of the agent, the plurality of strings associated with the first transaction file.

Clause 3: The method of any one of Clauses 1-2, further comprising: updating the context based on the actual reward, wherein updating the policy of the agent based on the response to the first string comprises updating the policy of the agent based on the updated context.

Clause 4: The method of any one of Clauses 1-3, wherein the expected reward for each string is based on a likelihood that a payment for a transaction associated with the first transaction file will be received.

Clause 5: The method of any one of Clauses 1-4, wherein: each string of the plurality of strings is associated with a topic of a plurality of topics, and the method further comprises ranking each respective topic in the plurality of topics based on an expected reward of the string associated with the respective topic.

Clause 6: The method of any one of Clauses 1-5, wherein: each attribute of the set of attributes is based on transaction data related to at least one of the entity, a payor associated with the first transaction file, or the first transaction file, and the attribute of the entity comprises one of: an amount of business of the entity; a maximum amount of a transaction associated with the first transaction file; a minimum amount of a transaction associated with the first transaction file; an industry associated with the entity; a location of the entity; a time associated with the first transaction file; a payment history of the payor associated with the first transaction file; an email address of the payor associated with the entity; a number of customers associated with the entity; or a number of transaction files per customer associated with the entity.

Clause 7: The method of any one of Clauses 1-6, wherein the context further comprises an attribute of a payor associated with the first transaction file.

Clause 8: A method, comprising: receiving a first transaction file associated with an entity; generating a first set of strings based on the first transaction file; determining an expected reward for each respective string of the first set of strings; receiving an actual reward for each respective string of the first set of strings; determining a first string of the first set of strings with a highest actual reward; generating a context of a set of attributes associated with the entity and the first transaction file based on the expected reward for each respective string, the actual reward for each respective string, and the first string with the highest actual reward; and training an agent to choose a string of a second set of strings for a second transaction file based on the context of the set of attributes when receiving the second transaction file as input.

Clause 9: The method of Clause 8, further comprising ranking each string in the first set of strings based on the expected reward for each respective string.

Clause 10: The method of any one of Clauses 8-9, further comprising: receiving transaction data of the entity based on the string of the second set of strings; updating the context of the set of attributes based on the transaction data; and training the agent to choose a third string of a third set of strings for a third transaction file based on the updated context when receiving the third transaction file as input.

Clause 11: The method of any one of Clauses 8-10, wherein each attribute of a set of attributes is based on transaction data related to at least one of the entity, a payor associated with the first transaction file, or the first transaction file, and wherein the set of attributes comprises at least one of: an amount of business of the entity; a maximum amount of a transaction associated with the first transaction file; a minimum amount of a transaction associated with the first transaction file; an industry associated with the entity; a location of the entity; a time associated with the first transaction file; a payment history of the payor associated with the first transaction file; an email address of the payor associated with the entity; a number of customers associated with the entity; or a number of transaction files per customer associated with the entity.

Clause 12: The method of any one of Clauses 8-11, wherein: the first transaction file is an invoice associated with the entity and a payor; and each string in the first set of strings is a personalized subject string for the invoice.

Clause 13: The method of any one of Clauses 8-12, wherein receiving the actual reward for each respective string of the first set of strings is further based on an action of a payor associated with the first transaction file.

Clause 14: The method of any one of Clauses 8-13, wherein each respective string is associated with a topic related to a likelihood that the entity will receive a payment associated with the first transaction file.

Clause 15: The method of any one of Clauses 8-14, wherein: the expected reward for each respective string is associated with a type of a plurality of types; and a value of the expected reward for each respective string is based on the type of the plurality of types.

Clause 16: A processing system, comprising: a memory comprising computer-executable instructions; one or more processors configured to execute the computer-executable instructions and cause the processing system to perform a method in accordance with any one of Clauses 1-15.

Clause 17: A processing system, comprising means for performing a method in accordance with any one of Clauses 1-15.

Clause 18: A non-transitory computer-readable medium comprising computer-executable instructions that, when executed by one or more processors of a processing system, cause the processing system to perform a method in accordance with any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of updating a policy of an agent, comprising:
receiving a first transaction file associated with an entity;
predicting, by the agent, an expected reward for each respective string of a plurality of strings associated with the first transaction file based on a policy of the agent, wherein the policy is determined based on a context comprising at least an attribute of the entity;
determining a first string based on a highest expected reward;
providing, to an environment, the first string;
receiving a response to the first string, wherein the response comprises an actual reward; and
updating the policy of the agent based on the response to the first string.

2. The method of claim 1, further comprising generating, based on the policy of the agent, the plurality of strings associated with the first transaction file.

3. The method of claim 1, further comprising:
updating the context based on the actual reward,
wherein updating the policy of the agent based on the response to the first string comprises updating the policy of the agent based on the updated context.

4. The method of claim 1, wherein the expected reward for each string is based on a likelihood that a payment for a transaction associated with the first transaction file will be received.

5. The method of claim 1, wherein:
each string of the plurality of strings is associated with a topic of a plurality of topics, and
the method further comprises ranking each respective topic in the plurality of topics based on an expected reward of the string associated with the respective topic.

6. The method of claim 1, wherein:
each attribute of a set of attributes is based on transaction data related to at least one of the entity, a payor associated with the first transaction file, or the first transaction file, wherein the set of attributes includes the attribute of the entity, and
the attribute of the entity comprises one of:
an amount of business of the entity;
a maximum amount of a transaction associated with the first transaction file;
a minimum amount of a transaction associated with the first transaction file;
an industry associated with the entity;
a location of the entity;
a time associated with the first transaction file;
a payment history of the payor associated with the first transaction file;
an email address of the payor associated with the entity;
a number of customers associated with the entity; or
a number of transaction files per customer associated with the entity.

7. The method of claim 1, wherein the context further comprises an attribute of a payor associated with the first transaction file.

8. A processing system, comprising:
a memory storing executable instructions; and
a processor configured to execute the executable instructions and cause the processing system to:
receive a first transaction file associated with an entity;
predict, by an agent, an expected reward for each respective string of a plurality of strings associated with the first transaction file based on a policy of the agent, wherein the policy is determined based on a context comprising at least an attribute of the entity;
determine a first string based on a highest expected reward;
provide, to an environment, the first string;
receive a response to the first string, wherein the response comprises an actual reward; and
update the policy of the agent based on the response to the first string.

9. The processing system of claim 8, wherein the processor is further configured to cause the processing system to generate, based on the policy of the agent, the plurality of strings associated with the first transaction file.

10. The processing system of claim 8, wherein the processor is further configured to cause the processing system to:
update the context based on the actual reward,
wherein updating the policy of the agent based on the response to the first string comprises updating the policy of the agent based on the updated context.

11. The processing system of claim 8, wherein the expected reward for each string is based on a likelihood that a payment for a transaction associated with the first transaction file will be received.

12. The processing system of claim 8, wherein:
each string of the plurality of strings is associated with a topic of a plurality of topics, and
wherein the processor is further configured to cause the processing system to rank each respective topic in the plurality of topics based on an expected reward of the string associated with the respective topic.

13. A method, comprising:
receiving a first transaction file associated with an entity;
generating a first set of strings based on the first transaction file;
determining an expected reward for each respective string of the first set of strings;
receiving an actual reward for each respective string of the first set of strings;
determining a first string of the first set of strings with a highest actual reward;
generating a context of a set of attributes associated with the entity and the first transaction file based on the expected reward for each respective string, the actual reward for each respective string, and the first string with the highest actual reward; and
training an agent to choose a string of a second set of strings for a second transaction file based on the context of the set of attributes when receiving the second transaction file as input.

14. The method of claim 13, further comprising ranking each string in the first set of strings based on the expected reward for each respective string.

15. The method of claim 13, further comprising:
receiving transaction data of the entity based on the string of the second set of strings;
updating the context of the set of attributes based on the transaction data; and
training the agent to choose a third string of a third set of strings for a third transaction file based on the updated context when receiving the third transaction file as input.

16. The method of claim 13, wherein each attribute of a set of attributes is based on transaction data related to at least one of the entity, a payor associated with the first transaction file, or the first transaction file, and wherein the set of attributes comprises at least one of:
an amount of business of the entity;
a maximum amount of a transaction associated with the first transaction file;
a minimum amount of a transaction associated with the first transaction file;
an industry associated with the entity;
a location of the entity;
a time associated with the first transaction file;
a payment history of the payor associated with the first transaction file;
an email address of the payor associated with the entity;
a number of customers associated with the entity; or
a number of transaction files per customer associated with the entity.

17. The method of claim 13, wherein:
the first transaction file is an invoice associated with the entity and a payor; and
each string in the first set of strings is a personalized subject string for the invoice.

18. The method of claim 13, wherein receiving the actual reward for each respective string of the first set of strings is further based on an action of a payor associated with the first transaction file.

19. The method of claim 13, wherein each respective string is associated with a topic related to a likelihood that the entity will receive a payment associated with the first transaction file.

20. The method of claim 13, wherein:
the expected reward for each respective string is associated with a type of a plurality of types; and
a value of the expected reward for each respective string is based on the type of the plurality of types.
